(19) United States
(12) Patent Application Publication
(10) Pub. No.: US 2026/0339637 A1
(43) Pub. Date: Oct. 29, 2026

(54) MANAGING OPERATION OF A DEPLOYMENT USING A SCORE BASED DEPLOYMENT PLAN

(71) Applicant: Dell Products L.P., Round Rock, TX (US)

(72) Inventors: MAXIM BALIN, Gan-Yavne (IL); ALEXANDER MOLEV, Beer Yaakov (IL)

(21) Appl. No.: 19/192,058

(22) Filed: Apr. 28, 2025

(51) Int. Cl. G06F 8/60; G06F 8/41

(52) U.S. Cl. CPC G06F 8/60; G06F 8/433

(57) ABSTRACT

Methods and systems for managing operation of a deployment hosting components distributed across edge resources and cloud resources of the deployment are disclosed. A scoring system may be used to quantitatively evaluate data indicating operation of the deployment. Sub-scores may be obtained using the scoring system for different characteristics of each component. The sub-scores may indicate, for example, resource intensity, dependency complexity, latency sensitivity, architectural complexity, and/or any other characteristics of the components. An aggregated score may be obtained based on the sub-scores and used to classify the components with respect to being hosted on the edge resources and/or the cloud resources. A deployment plan may be obtained and finalized for use in updating the operation of the deployment.

### FIELD

Embodiments disclosed herein relate generally to managing operation of a deployment. More particularly, embodiments disclosed herein relate to managing operation of the deployment hosting components distributed across edge resources and cloud resources of the deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows an interaction diagram in accordance with an embodiment.

FIG. 2B shows a data flow diagram in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment comprising edge resources and cloud resources. To manage operation of the deployment, a deployment plan may be used to update operation of the deployment.

The deployment may provide computer-implemented services by hosting a plurality of components distributed across the edge resources and cloud resources (e.g., private cloud resources, public cloud resources, etc.). For example, the components may be hosted in a hybrid environment in which some components are hosted on edge resources, some other components are hosted on private cloud resources, and/or some other components are hosted on public cloud resources. Each of the components may interact with each other to provide at least a portion of the computer-implemented services.

Because each of the resources may have different advantages and/or limitations, a quality of computer-implemented services provided by the deployment may be impacted by a configuration of components of the deployment with respect to being hosted on edge resources and/or cloud resources. For example, some components being hosted on edge resources (e.g., edge devices) may reduce latency, reduce cost, improve resiliency, and/or provide any other benefits while providing computer-implemented services.

However, some other components may require services provided by cloud resources that may not be available to edge resources. To improve a likelihood that the deployment may provide desired computer-implemented services, a deployment plan may be used to update operation of the deployment. For example, the deployment plan may indicate that some components are to be migrated from public cloud resources to edge resources. To obtain the deployment plan, data may be obtained that indicates operation of the deployment.

The data for a component may be evaluated to classify the component with respect to edge compatibility. To do so, a scoring system may be used to generate sub-scores related to operation of the component, obtain an aggregate core based on a weighting function applied to the sub-scores, classify the component based on the aggregate score, and/or provide any other information. The sub-scores may include, for example, a resource intensity score (e.g., level of demand for computational resources for the component), a dependency complexity score (e.g., level of dependency that the component has on other services), a latency sensitivity score (e.g., level of immediacy with respect to response times required for the component), an architectural complexity score (e.g., level of complexity of a design of the component), and/or any other scores. Each sub-score may be computed based on at least the data obtained from the deployment.

A first deployment plan may be obtained based on least in part on the aggregate scores for the components, capabilities and/or limitations of edge resources of the deployment, and/or any other information. The first deployment plan may be finalized, for example, by iteratively performing simulations of operation using the first deployment plan to obtain simulated outcomes and making changes to the deployment plan based on the simulated outcomes (e.g., until at least one of the simulated outcomes meets criteria).

By doing so, a final deployment plan may be obtained for use in updating operation of the deployment. The deployment may be updated, for example, by migrating at least a portion of the components of the deployment from a cloud resource to an edge resource in an incremental manner based on the final deployment plan. Furthermore, the updated deployment may be managed by monitoring the operation of the updated deployment and/or obtaining a new deployment plan based on the updated operation.

In an embodiment, a method for managing operation of a deployment is provided. The method may include: (i) obtaining data indicating operation of the deployment, the deployment comprising edge resources, private cloud resources, and public cloud resources, and the deployment hosting a plurality of components distributed across the edge resources, private cloud resources, and public cloud resources; (ii) evaluating, using a scoring system, the data to obtain a deployment plan, the scoring system being adapted to, for at least one component of the plurality of components: (a) generate sub-scores for different characteristics of the at least one component indicated by the data, (b) combine the sub-scores to obtain an aggregate score for the at least one component, (c) classify the at least one component with respect to edge compatibility based on the aggregate score; (iii) finalizing the deployment plan to obtain a finalized deployment plan; and (iv) updating operation of the deployment using the finalized deployment plan to facilitate provisioning of desired computer implemented services.

The data may include at least one type of data from a list consisting of: (i) performance metrics for the deployment; (ii) resource utilization data for the deployment; (iii) information regarding dependencies for components of the deployment; and (iv) configuration information for the deployment.

Evaluating the data may include: (i) generating, for a component of the plurality of components of the deployment, the sub-scores using the scoring system; (ii) applying a weighting function to the sub-scores to obtain the aggregate score; (iii) classifying, based on the aggregate score, the component: (a) with respect to being hosted on at least one resource of a group of resources used by the deployment, the group of resources consisting of: (i) an edge resource of the edge resources, (ii) a private cloud resource of the private cloud resources or a public cloud resource of the public cloud resources, (iii) the edge resources of the edge resources after modification of the component for compatibility with the edge resource, and (b) as part of the deployment plan.

The sub-scores may include a resource intensity score that indicates a level of demand for computational resources required for desired operation of the component.

The sub-scores may include a dependency complexity score that indicates a level of dependency that the component has on other services.

The sub-scores may include a latency sensitivity score that indicates a level of immediacy with respect to response times required for desired operation of the component.

The sub-scores may include an architectural complexity score based on a set of factors related to an architectural structure of the component, the set of factors comprising: (i) modularity; (ii) resiliency; and (iii) edge compatibility.

Finalizing the deployment plan may include: (i) iteratively performing simulations of operation of the using the deployment plan to obtain simulated outcomes; (ii) while iteratively performing the simulations, iteratively making changes to the deployment plan until at least one of the simulated outcomes meets criteria; and (iii) obtaining a finalized deployment plan based on the iteratively made changes to the deployment plan.

Updating the operation of the deployment may include: (i) migrating at least a portion of the plurality of the components of the deployment that is hosted on a cloud resource of the cloud resources to an edge resource of the edge resources based on the finalized deployment plan.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

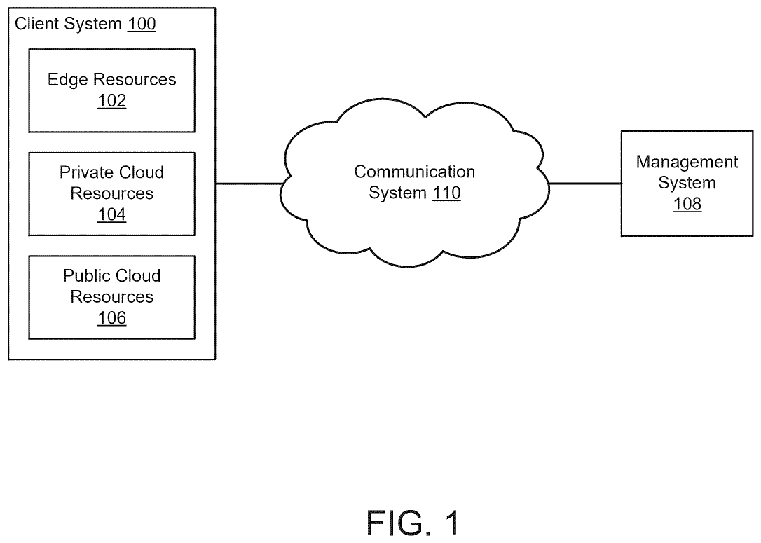

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, client system 100, management system 108, and/or any other type of devices (not shown in FIG. 1). Other types of computer-implemented services may be provided by the system shown in FIG. 1 without departing from embodiments disclosed herein.

To provide the computer-implemented services, the system may include client system 100. Client system 100 may include a deployment that may host any number and/or types of components (e.g., software services, etc.). The components may be hosted on any number and/or type of resources that may include, for example, edge resources 102, private cloud resources 104, public cloud resources 106, and/or any other type of resources (not shown in FIG. 1). For example, the components of client system 100 may be deployed in a predetermined configuration that distributes the components across edge resources 102, private cloud resources 104, and/or public cloud resources 106 to provide the computer-implemented services.

Public cloud resources 106 may include, for example, a cloud infrastructure that provides remote computing services to any number and/or type of users (e.g., client system 100 and/or other systems for other users, not shown in FIG. 1). To provide the remote computing services, public cloud resources 106 may host software components that may operate using hardware resources owned by a third-party cloud service provider. As such, public cloud resources 106 may provide advantages, with respect to computer-implemented services provided by client system 100, that may include, for example, reduced cost for hardware resources, flexibility to scale services based on dynamic workloads, services provided by the third-party cloud service provider, and/or any other advantages. However, public cloud resources may also be subject to disadvantages that may include, for example, performance variability (e.g., network latency, resource throttling, etc.), security/compliance concerns, limited control regarding policies, cost variability, and/or any other disadvantages.

Private cloud resources 104 may include, for example, a second cloud infrastructure that provides remote computing services to client system 100. The remote computer services may be provided by private cloud resources 104 using hardware resources owned by and/or exclusively used by an owner of client system 100. As such, private cloud resources 104 may provide similar and/or different advantages and disadvantages compared to public cloud resources 106. For example, compared to public cloud resources 106, private cloud resources 104 may provide increased security/privacy, increased infrastructure control, and/or other advantages. However, compared to public cloud resources 106, private cloud resources 104 may be subject to increased costs (e.g., hardware costs, operational costs, etc.), limitations for scaling services based on resource constraints, more complex management, location constraints, and/or any other disadvantages.

Edge resources 102 may include, for example, an edge deployment including any number and/or type of edge devices (e.g., data processing systems) that may be deployed to a physical location for providing at least a portion of the computer-implemented services provided by client system 100. Each edge device of edge resources 102 may independently and/or cooperatively generate and/or process data and may do so in a decentralized manner (e.g., without transmitting the data to a centralized server). As such, edge resources 102 may provide advantages compared to public cloud resources 106 and/or private cloud resources 104, that may include, for example, reduced latency, bandwidth optimization, enhanced security, and/or any other advantages. However, edge resources 102 may be subject to disadvantages that may include, for example, limitations in processing power and storage capacity, complexity in management, and/or any other disadvantages.

As previously discussed, public cloud resources 106, private cloud resources 104, and edge resources 102 may each offer distinct advantages and disadvantages. Client system 100 may attempt to leverage the advantages and/or disadvantages by configuring the deployment such that components of the deployment are distributed across the resources. The distribution of the components may be configured by an entity tasked with managing the deployment (e.g., a development and operations engineer, an administrator, an operations team, etc.). For example, portions of the deployment may be migrated from public cloud resources 106 to edge resources 102 based on a knowledge base and/or decision made by the entity.

However, a quality of the computer-implemented services provided by client system 100 may be negatively impacted if the deployment is deployed in a sub-optimal manner. For example, the deployment may be deployed in a sub-optimal manner based on a limited knowledge base of the entity, inaccurate assessment of workloads for the components, and/or any other limitations. Consequently, client system 100 may provide undesired computer-implemented services that may be subject to, for example, under-utilized resources, reduced performance, increased cost, and/or any other negative impacts.

In general, embodiments disclosed herein may provide methods, systems, and/or devices for managing operation of a deployment. To improve a quality of computer-implemented services provided by the deployment, a quantitative assessment of the deployment may be performed based on data indicating operation of the deployment to obtain a deployment plan.

To do so, management system 108 (e.g., a data processing system tasked with managing at least client system 100) may obtain the data from client system 100. The data may include, for example, performance metrics for the deployment (e.g., central processing unit usage, memory consumption, storage, network bandwidth usage, etc.), resource utilization data for the deployment (e.g., peak usage, average usage, seasonal variations, idle times, etc.), information regarding dependencies for components of the deployment (e.g., microservices, application programming interfaces (API), databases, third-party integrations, etc.), configuration information for the deployment (e.g., technology stack heterogeneity, coupling between services, etc.), workloads performed by the deployment, and/or any other information indicating operation of the deployment.

To perform the quantitative assessment, the data for a component may be evaluated to classify the component with respect to edge compatibility. To do so, a scoring system may be used to generate sub-scores related to operation of the component, obtain an aggregate core based on a weighting function applied to the sub-scores, classify the component based on the aggregate score, and/or provide any other information. The sub-scores may include, for example, a resource intensity score, a dependency complexity score, a latency sensitivity score, an architectural complexity score, and/or any other scores. Each sub-score may be computed based on at least the data obtained from the deployment.

The resource intensity score may indicate a level of demand for computation resources for the component. For example, the resource intensity score may be calculated based on a result of adding a first ratio of peak central processing unit (CPU) usage to target edge CPU limit, a second ratio of peak memory usage to target edge memory limit, and a third ratio of storage usage to target edge storage capacity. As such, the resource intensity score may consider CPU architectures, storage compression techniques, data locality, and/or any other characteristics of the component. A lower resource intensity score (e.g., 0-3) may, for example, indicate lower resource demands that may be more compatible for being hosted on edge resources 102 compared to a higher resource intensity score (e.g., 7 and higher) that may indicate higher resource demands that may be better suited to be hosted on a cloud resource.

The dependency complexity score may indicate level of dependency that the component has on other services. For example, a weight may be assigned to each dependency of the component based on its criticality and/or complexity. For example, a critical level dependency (e.g., database, authentication service, etc.) may be assigned a higher weight (e.g., 3 points), a moderate level dependency (e.g., third-party API, monitoring tools, etc.) may be assigned a moderate weight (e.g., 2 points), and a low-level dependency may be assigned a lower weight (e.g., 1 points). The dependency complexity score may subsequently be calculated by adding all of the weights for the dependencies of the component. As such, the dependency complexity score may consider a total number of services the component depends on, degree of integration between services, diversity of technology stacks utilized for the component, and/or any other characteristics of the component.

The latency sensitivity score may indicate a level of immediacy with respect to response times required for the component. A latency sensitivity score may be assigned for each component based on an average response time required for tasks performed by the component. For example, a higher sensitivity component (e.g., average response time for tasks being less than 10 milliseconds) may be assigned a higher sub-score (e.g., 3 points), a moderate sensitivity component (e.g., average response time for tasks being between 10 and 50 milliseconds) may be assigned a moderate sub-score (e.g., 2 points), and a lower sensitivity component (e.g., average response time for tasks being greater than 50 milliseconds). As such, the latency sensitivity score may consider workload processing times, offline capability (e.g., ability to operate without continuous connectivity to cloud resources), synchronization requirements (e.g., frequency of updates between an edge resource and cloud resources), and/or any other characteristics of the component.

The architectural complexity score may indicate an overall complexity of a component's design and suitability for migration to edge resources. An architectural complexity score may be assigned to a component based on any number and/or type of factors that may include, for example, modularity of the component (e.g., 1 point for a component that has a modular architecture, 3 points for a component that has a monolithic architecture, etc.), resiliency of the component (e.g., 1 point for a component that has a fault-tolerant design, 3 points for a component that has a fragile design, etc.), edge compatibility of the component with respect to edge orchestration tools (e.g., 0 points for native edge compatibility, 3 points for being incompatible, etc.), and/or any other factors. The architectural complexity score for a component may be subsequently obtained by adding points for each of the factors.

Once obtained, the sub-scores may be weighted to obtain an aggregate score. To obtain the aggregate score for a component, each sub-score (e.g., the resource intensity score, the dependency complexity score, the latency sensitivity score, the architectural complexity score, etc.) for the component may be weighted using a weighting function to reflect a corresponding level of importance with respect to evaluating an ability of the component to migrate to edge resources 102. For example, the aggregate score may be obtained by adding: (i) a product of the resource intensity score and a first weight (e.g., 0.4), (ii) a product of the dependency complexity score and a second weight (e.g., 0.3), (iii) a product of the latency sensitivity score and a third weight (e.g., 0.2), and (iv) a product of the architectural complexity score and a fourth weight (e.g., 0.1).

The aggregate score may subsequently be used to classify the component with respect to being hosted on edge resources 102, private cloud resources 104 or public cloud resources 106, edge resources 102 following modification of the component to increase compatibility with edge resources 102, and/or any other configurations. For example, a lower aggregate score (e.g., equal to or less than 4 points) may indicate that the component may be more likely to perform its functionality while being hosted on edge resources 102, a moderate aggregate score (e.g., between 4 and 6 points) may indicate that the component may be more likely to perform its functionality while being hosted on edge resources 102 if the component is modified in a certain manner, and a higher aggregate score may indicate that the component is more likely to provide perform its functionality while being hosted on public cloud resources 106 and/or private cloud resources 104. An aggregate score may be obtained, for example, for each component of a deployment for client system 100.

A deployment plan may be obtained based on the aggregate scores for the components, capabilities and/or limitations of edge resources 102 of the deployment, and/or any other information. For example, the deployment plan may be obtained by prioritizing components based on the aggregate scores and/or any of the sub-scores, partitioning the components into edge tasks (e.g., that may require low latency, local processing, etc.) and/or cloud tasks (e.g., that may require more computational resources, etc.), defining rules for interactions between the edge tasks and cloud tasks, and/or via any other processes. The deployment plan may include partitioned workloads with deployment configuration adapted to edge resources 102.

To improve a likelihood that client system 100 may provide the desired computer-implemented services based on implementation of the deployment plan, the deployment plan may be finalized via validation of the deployment plan. The deployment plan may be validated, for example, by iteratively performing simulations of the operation of the deployment using a digital twin of the deployment (e.g., components of the deployment, edge resource, cloud resources, etc.) and the deployment plan to obtain simulated outcomes. Changes may be iteratively made to the deployment plan based on the iteratively obtained simulated outcomes until at least one of the simulated outcomes meets criteria.

By doing so, a final deployment plan may be obtained for use in updating operation of the deployment. The deployment may be updated, for example, by migrating at least a portion of the components of the deployment from a cloud resource to an edge resource in an incremental manner based on the final deployment plan. Furthermore, the updated deployment may be managed by monitoring the operation of the updated deployment and/or obtaining a new deployment plan based on the updated operation.

To provide the above noted functionality, the system may include client system 100, and management system 108. Each of these components is discussed below.

Client system 100 may include any number of components (e.g., software components, hardware components, etc.) that may provide at least a portion of the computer-implemented services (e.g., to users of client system 100). To do so, the components may be deployed in a distributed manner across edge resources 102, private cloud resources 104, public cloud resources 106, and/or any other resources (not shown in FIG. 1). The components may be hosted in the distributed manner based on a deployment plan obtained from management system 108.

As discussed above, management system 108 may provide deployment management services (e.g., for client system 100). To provide the deployment management services, management system 108 may (i) obtain data indicating operation of a deployment of client system 100, (ii) evaluate the data using a scoring system to obtain sub-scores for different characteristics for each component of client systems 100, (iii) aggregate the sub-scores (e.g., using a weighting function) to obtain an aggregate score for each component, (iv) generate a deployment plan based on the aggregates and other information, (v) perform validations to modify and/or finalize the deployment plan, (vi) provide the finalized deployment plan to client system 100 to update operation of the deployment of client system 100 and/or perform any other actions.

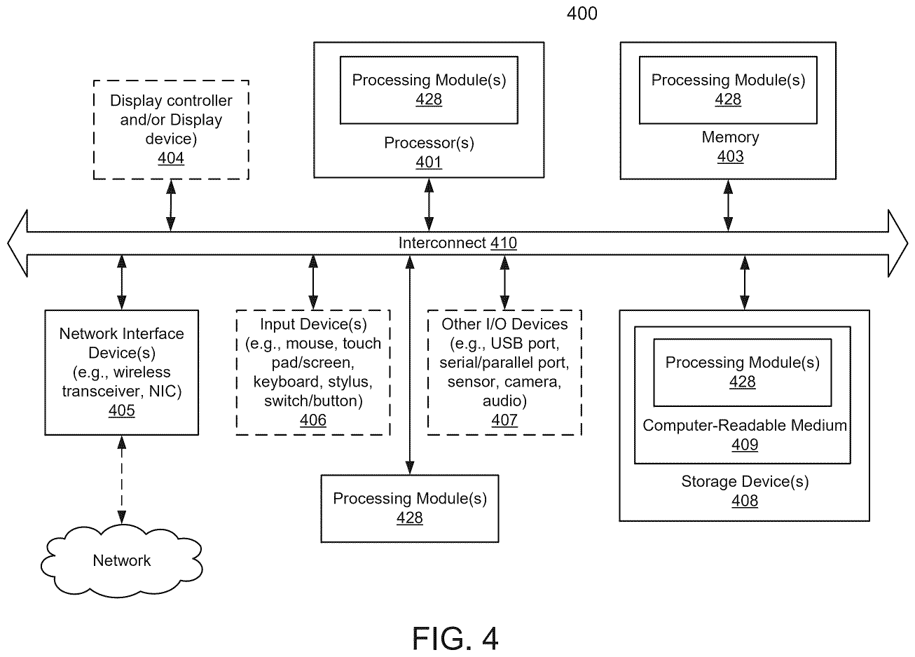

Communication system 110 may allow any of client system 100, edge resources 102, private cloud resources 104, public cloud resources 106, and management system 108 to communicate with one another (and/or with other devices not illustrated in FIG. 1). To provide its functionality, communication system 110 may be implemented with one or more wired and/or wireless networks. Any of these networks may be a private network (e.g., the “Network” shown in FIG. 4), a public network, and/or may include the Internet. For example, client system 100 may be operably connected to management system 108 via the Internet. Client system 100, management system 108, and/or communication system 110 may be adapted to perform one or more protocols for communicating via communication system 110.

Any of (and/or components thereof) client system 100, edge resources 102, private cloud resources 104, public cloud resources 106, and management system 108 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of a deployment using a deployment plan based on data indicating operation of the deployment. The deployment plan may be obtained by quantitatively assessing the data with respect to edge resource and/or cloud resource compatibility using a scoring system. By doing so, a quality of computer-implemented services provided by the deployment configured using the deployment plan may be improved.

While illustrated in FIG. 1 with a limited number of specific components, a system may include additional, fewer, and/or different components without departing from embodiments disclosed herein.

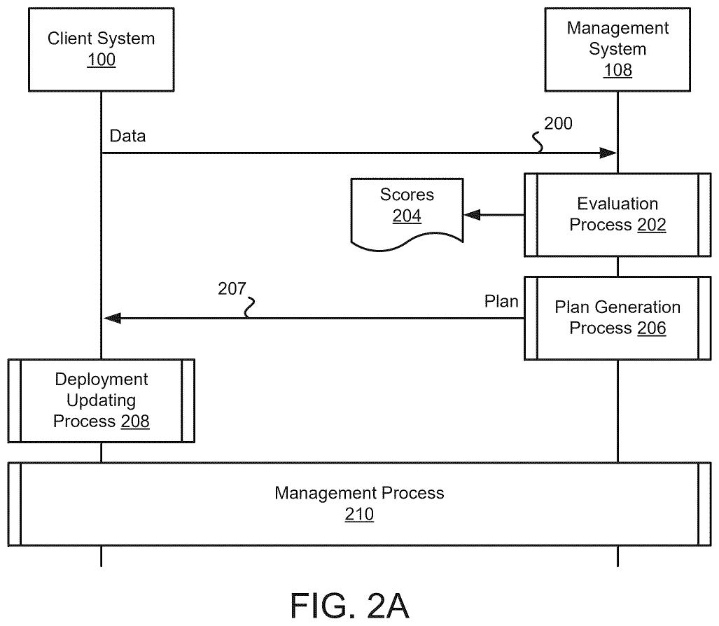

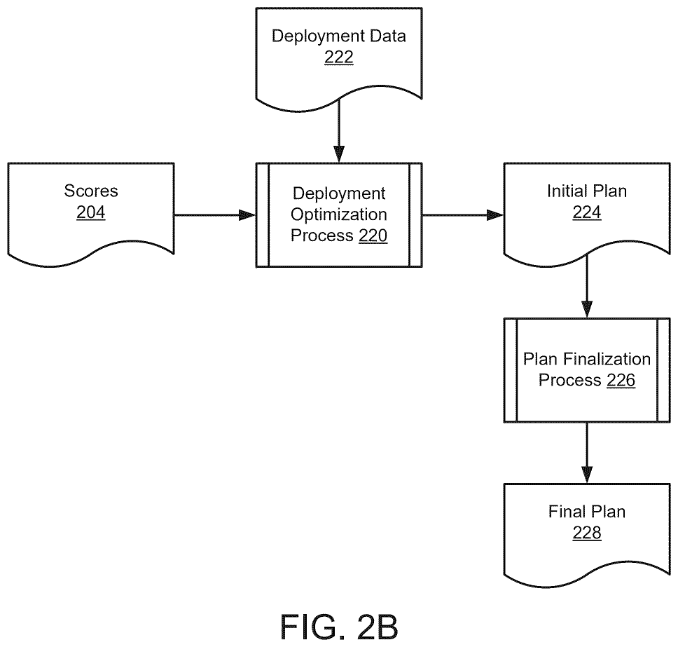

To further clarify embodiments disclosed herein, an interaction diagram in accordance with an embodiment is shown in FIG. 2A. The interaction diagram may illustrate how data may be obtained and used within the system of FIG. 1.

In the interaction diagram, processes performed by and interactions between components of a system in accordance with an embodiment are shown. In the diagram, components of the system are illustrated using a first set of shapes (e.g., 100, 108, etc.), located towards the top of each figure. Lines descend from these shapes. Processes performed by the components of the system are illustrated using a second set of shapes (e.g., 202, 206, etc.) superimposed over these lines. Interactions (e.g., communication, data transmissions, etc.) between the components of the system are illustrated using a third set of shapes (e.g., 200, 208, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 200 may occur prior to the process labeled as 202. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during managing operation of a deployment using a deployment plan.

To manage the operation of the deployment, data indicating operation of the deployment may be provided to management system 108 by client system 100 at interaction 200. The data may include, for example, performance metrics for the deployment (e.g., CPU usage, memory consumption, storage, network bandwidth usage, etc.), resource utilization data for the deployment (e.g., peak usage, average usage, seasonal variations, idle times, etc.), information regarding dependencies for components of the deployment (e.g., microservices, application programming interfaces (API), databases, third-party integrations, etc.), configuration information for the deployment (e.g., technology stack heterogeneity, coupling between services, etc.), workloads performed by the deployment, and/or any other information indicating operation of the deployment. The data may be provided to management system 108, for example, by (i) requesting the data from client system 100 (e.g., based on an event, a schedule, etc.), (ii) monitoring operation of the deployment of client system 100, (iii) receiving the data from client system 100, and/or any other methods.

To quantitatively assess components of client system 100 based on the data, evaluation process 202 may be performed. During evaluation process 202, sub-scores may be generated for each component of a deployment of client system 100, an aggregate score may be obtained based on the sub-scores, and the component may be classified using the aggregate score. For example, to generate the sub-scores for a component, the data may be analyzed by management system 108 using a scoring system (e.g., an algorithm, a trained machine learning model, etc.) to assign quantitative scores to the component that indicates different characteristics of the component with respect to edge compatibility. The sub-scores may include, for example, a resource intensity score, a dependency complexity score, a latency sensitivity score, an architectural complexity score, and/or any other scores. Each of the sub-scores may be obtained, for example, by performing a calculation using a relevant portion of the data, assigning weights based on the relevant portion of the data, and/or via any other processes.

To obtain the aggregate score for a component, a weighting function may be applied to the sub-scores for the component. The weighting function may be defined, for example, by a subject matter expert, historical analysis of the data and/or operation of the deployment, and/or via any other processes. Once obtained, the aggregate scores for the components of client system 100 may be used to classify the components with respect to being hosted on edge resources and/or cloud resources. For example, to classify a component, the aggregate score for the component may be compared to criteria (e.g., thresholds for different classifications), a rule-based classification system may be used, and/or via any other processes.

As a result of performing evaluation process 202, scores 204 may be obtained. Scores 204 may be a data structure that may include any number and/or type of information relevant to the quantitative assessment of the components of client system 100. For example, scores 204 may include the sub-scores, the aggregate score, the classification of the component based on the aggregate score and/or any other information based on evaluation of the data for client system 100.

To obtain a deployment plan for client system 100, plan generation process 206 may be performed. During plan generation process 206, an initial deployment plan may be obtained based on the classification of the components, and the initial deployment plan may be finalized to obtain a final deployment plan. For example, to obtain the initial deployment plan, the components may be partitioned based on scores 204 to obtain new deployment configuration for client system 100. The initial deployment plan may be finalized by validating the new deployment configuration based on hardware compatibility with the edge resources. For example, management system 108 may perform any number of simulations using the initial deployment plan to verify a quality of the deployment plan (e.g., interruptions to computer-implemented services, performance, data consistency, etc.). By doing so, a finalized deployment plan may be obtained. Refer to FIG. 2B for additional information regarding obtaining the finalized deployment plan.

At interaction 207, the finalized deployment plan may be provided to client system 100 by management system 108. The finalized deployment plan may be provided to client system 100 by: (i) providing the finalized deployment plan to be processed by a local management entity of client system 100, (ii) providing instructions to client system 100 based on the finalized deployment plan, (iii) initiating performance of an action to implement the finalized deployment plan, and/or via any other processes.

To update operation of the deployment of client system 100, deployment updating process 208 may be performed. During deployment updating process 208, operation of the deployment may be updated based on the finalized deployment plan. For example, the operation may be updated by: (i) configuring hardware resources of the edge resources to host newly identified components of client system 100 with respect to migration to the edge resources, (ii) establishing network configurations for the components, (iii) migrating the components of client system 100 according to the finalized deployment plan (e.g., incrementally based on prioritization of the components), (iv) validating the updated deployment (e.g., by performing tests), and/or performing any other actions.

To manage operation of the updated deployment, management process 210 may be performed. During management process 210, information may be obtained indicating operation of the updated deployment, and improvements may be identified based on the information. For example, to obtain the information, management system 108 may (i) monitor the operation to collect performance metrics (e.g., latency, CPU usage, memory usage, disk input/output, etc.), (ii) collect information regarding network health (e.g., bandwidth, packet loss, latency, etc.), (iii) trigger alerts for performance anomalies (e.g., based on defined thresholds), and/or perform any other actions.

Based on the information, management system 108 may make iterative improvements to the operation and/or the finalized deployment plan. To do so, management system 108 may (i) implement fallback mechanisms (e.g., offloading workloads to cloud resources, (ii) remotely storing data from the edge resources as backup at least temporarily, etc.), (iii) analyze the information regarding the operation of the updated deployment, (iv) obtain feedback regarding a quality of the services provided by the updated deployment, (v) refine component partitioning based on analyzed patterns, and/or perform any other actions.

Thus, using the interactions diagram shown in FIG. 2A, a deployment may be updated using a score-based deployment plan based on data indicating operation of the deployment in a current state. The deployment plan may be used to update operation of the deployment to facilitate provisioning of desired computer-implemented services.

To further clarify embodiments disclosed herein, a data flow diagram in accordance with an embodiment is shown in FIG. 2A. In the diagram, flows of data and processing of data are illustrated using different sets of shapes. A first set of shapes (e.g., 204, 222, etc.) is used to represent data structures, and a second set of shapes (e.g., 220, 226, etc.) is used to represent processes performed using and/or that generate data.

Turning to FIG. 2B, a data flow diagram in accordance with an embodiment is shown. The data flow diagram may illustrate data used in and data processing performed in obtaining a finalized deployment plan based on data indicating operation of a deployment.

To obtain the finalized deployment plan, deployment optimization process 220 may be performed. During deployment optimization process 220, an initial deployment plan may be obtained based on information regarding the deployment (e.g., in a current operating state). For example, to obtain the initial deployment plan, management system 108 may evaluate scores 204 along with deployment data 222. Deployment data 222 may include, for example, the data indicating operation of the deployment (e.g., as discussed in FIG. 2A), additional information regarding edge resources 102 (e.g., software and/or hardware capabilities of edge resources 102), and/or any other information.

Thus, to obtain initial plan 224, (i) a list of edge-compatible components of client system 100 may be identified based on scores 204, (ii) modifications to a portion of the components that may be edge-compatible may be identified, (iii) components may be prioritized for migration based on scores 204 (e.g., criticality to deployment functionality, resource consumption levels, latency sensitivity, etc.), (iv) workloads of the components may be partitioned, and/or any other processes may be performed. Furthermore, for components that are identified to be hosted on the edge resources and/or may be hosted on the edge resources after modification, optimization rules may be defined to manage resource usage (e.g., data compression, local data storage, data synchronization with cloud resources, etc.).

As such, initial plan 224 may be obtained that may define the portion of components of client system 100 to be hosted by edge resources, modification of a second portion of components (e.g., that may enable the second portion of the components to be hosted by the edge resources), rules for deploying the first portion and the second portion of the components to the edge resources, and/or any other information.

To finalize initial plan 224, plan finalization process 226 may be performed. During plan finalization process 226, initial plan 224 may be validated and updated to improve a likelihood that client system 100 may provide desired computer-implemented services when using the deployment plan. For example, to validate and update initial plan 224, operation of a deployment using the initial deployment plan may be simulated using a digital twin of at least a portion of client system 100. The digital twin may include, for example, a virtual image of edge resources 102, private cloud resources 104, and public cloud resources 106 that is configured to mirror characteristics of client system 100. When configured to operate using initial plan 224 and perform at least similar workloads of client system 100, a quality of the operations performed by the digital twin may be monitored to obtain a simulation outcome (e.g., performance metrics, quantitative and/or qualitative assessment, etc.).

While performing the simulations, changes may be iteratively made to the deployment plan (e.g., iteratively modified versions of initial plan 224) until at least one of the simulated outcomes meets criteria (e.g., desired performance metrics). By doing so, final plan 228 may be obtained. Final plan 228 may similarly, to initial plan 224, define components of client system 100 to be migrated to edge resource, modifications to the components, rules for configuring the deployment, and/or any other information regarding updating the operation of deployment that may improve a likelihood that client system 100 may provide desired computer-implemented services.

Thus, using the data flow shown in FIG. 2B, a deployment plan may be obtained based on data for a deployment. The deployment plan may be optimized to identify at least a portion of the components of the deployment to be hosted on edge resources of the deployment. The deployment plan may also be finalized to improve a likelihood that client system 100 may provide desired computer-implemented services when using the finalized deployment plan.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

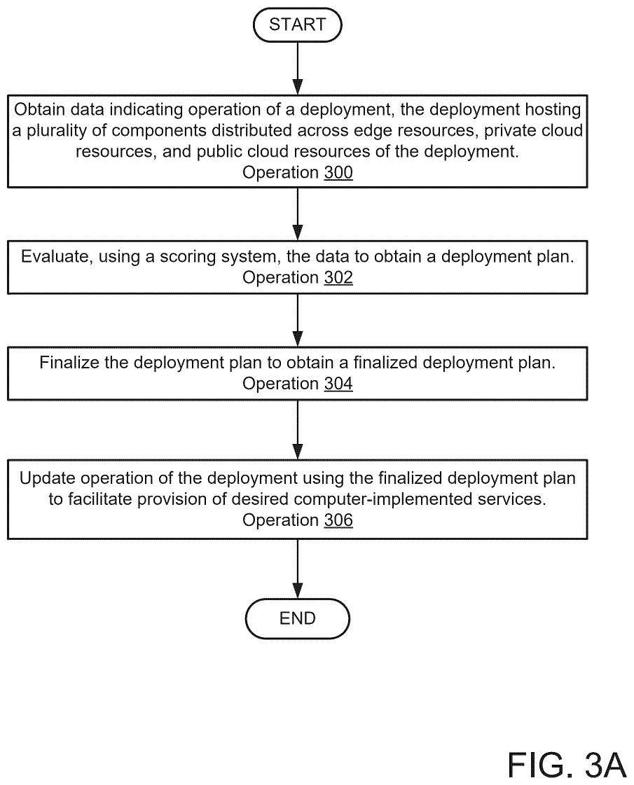

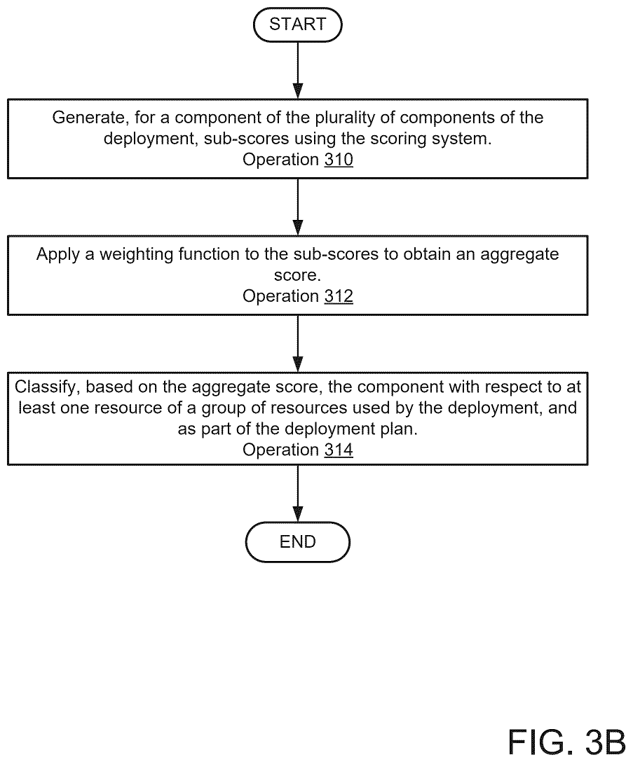

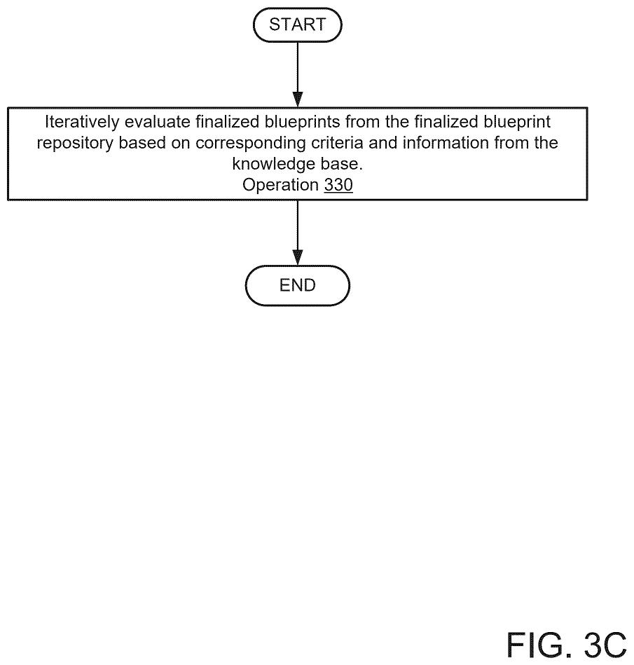

As discussed above, the components of FIG. 1 may perform various methods to manage data processing systems. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing operation of a deployment in accordance with an embodiment is shown. The method may be performed, for example, by any of the components of the system of FIG. 1, and/or other components not shown therein.

At operation 300, data may be obtained indicating operation of the deployment. The data may be obtained by: (i) receiving a data package from an administrator of the deployment, (ii) subscribing to data based on events triggered based on criteria (e.g., based on a schedule, alerts, etc.), (iii) requesting the data from the administrator of the deployment, and/or performing any other actions.

At operation 302, the data may be evaluated using a scoring system to obtain a deployment plan. The data may be evaluated by: (i) processing the data using a trained machine learning model, (ii) performing predetermined calculations to obtain sub-scores for different characteristics of the components, (iii) comparing the data to constraints of the edge resources of the deployment, (iv) obtaining aggregate scores using the sub-scores, (v) classifying the components based on the aggregate scores, (iv) obtaining a new deployment configuration for the deployment, and/or performing any other actions. Refer to FIG. 3B for additional information regarding evaluating the data to obtain a deployment plan.

At operation 304, the deployment plan may be finalized to obtain a finalized deployment plan. The deployment plan may be finalized by: (i) performing tests to validate an efficacy of the deployment while using the deployment plan, (ii) simulating performance of the deployment using a digital twin (e.g., virtual machines) of the edge resources and the cloud resources, (iii) modifying the deployment plan based on results of the simulated performance and criteria (e.g., performance thresholds), and/or performing any other actions.

At operation 306, operation of the deployment may be updated using the finalized deployment plan to facilitate provisioning of desired computer-implemented services. The operation of the deployment may be updated by: (i) refactoring a portion of software resources to be more edge compatible (e.g., installing packages to enable interaction with edge orchestration tools, modifying a design of the portion of the software resources to be modular, etc.), (ii) migrating components of the deployment to the edge resources according the finalized deployment plan (e.g., in a defined order based on prioritization, incrementally migrated components, etc.), (iii) scaling edge resources and/or cloud resources to meet workload requirements indicated by the finalized deployment plan, (iv) monitoring operation of the updated deployment, (v) making changes to the plan based on information indicating operation of the updated deployment, and/or via any other processes.

The method may end following operation 306.

Using the method shown in FIG. 3A, operation of a deployment may be managed using a deployment plan based on data indicating operation of the deployment. The data may be evaluated to obtain a deployment plan. The deployment plan may subsequently be finalized and used to update operation of the deployment.

Turning to FIG. 3B, a second flow diagram illustrating a method of evaluating data indicating operation of the deployment in accordance with an embodiment is shown. The method may be performed, for example, by any of the components of the system of FIG. 1, and/or other components not shown therein.

At operation 310, sub-scores may be generated for a component of the plurality of components of the deployment. The sub-scores may be generated by: (i) performing calculations to obtain a predefined set of sub-scores, (ii) providing at least the data as input to a trained machine learning model to obtain a response indicating the sub-scores, and/or via any other processes. The sub-scores may quantitively assess characteristics of the components and may include, for example, a resource intensity score (e.g., level of demand for computational resources for the component), a dependency complexity score (e.g., level of dependency that the component has on other services), a latency sensitivity score (e.g., level of immediacy with respect to response times required for the component), an architectural complexity score (e.g., level of complexity of a design of the component), and/or any other scores.

At operation 312, a weighting function may be applied to the sub-scores to obtain an aggregate score. The weighting function may be applied by: (i) attributing a level of importance to each sub-score, (ii) calculating the aggregate score using the sub-scores and the attributed levels of importance, (iii) using the sub-scores and a set of weights as input to the trained machine learning model, and/or via any other processes. For example, the aggregate score may be calculated by adding: (i) a product of the resource intensity score and a first weight (e.g., 0.4), (ii) a product of the dependency complexity score and a second weight (e.g., 0.3), (iii) a product of the latency sensitivity score and a third weight (e.g., 0.2), and (iv) a product of the architectural complexity score and a fourth weight (e.g., 0.1).

At operation 314, the component may be classified based on the aggregate score. The component may be classified by: (i) comparing the aggregate score for the component may be compared to criteria (e.g., thresholds for different classifications), (ii) using a clustering algorithm to classify components based on the aggregate score, and/or via any other processes.

The method may end following operation 314.

Using the method shown in FIG. 3B, data indicating operation of the deployment may be quantitively assessed to obtain predefined sub-scores. An aggregate score for the component may be obtained based on the sub-scores and used to classify components with respect to edge resource and/or cloud resource compatibility for updating operation of the deployment.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-SUBSTITUTE readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
obtaining data indicating operation of the deployment, the deployment comprising edge resources, private cloud resources, and public cloud resources, and the deployment hosting a plurality of components distributed across the edge resources, private cloud resources, and public cloud resources;
evaluating, using a scoring system, the data to obtain a deployment plan, the scoring system being adapted to, for at least one component of the plurality of components:
generate sub-scores for different characteristics of the at least one component indicated by the data,
combine the sub-scores to obtain an aggregate score for the at least one component, and
classify the at least one component with respect to edge compatibility based on the aggregate score;
finalizing the deployment plan to obtain a finalized deployment plan; and
updating operation of the deployment using the finalized deployment plan to facilitate provisioning of desired computer implemented services.

2. The method of claim 1, wherein the data comprises at least one type of data from a list consisting of:
performance metrics for the deployment;
resource utilization data for the deployment;
information regarding dependencies for components of the deployment; and
configuration information for the deployment.

3. The method of claim 1, wherein evaluating the data comprises:
generating, for a component of the plurality of components of the deployment, the sub-scores using the scoring system;
applying a weighting function to the sub-scores to obtain the aggregate score; and
classifying, based on the aggregate score, the component:
with respect to being hosted on at least one resource of a group of resources used by the deployment, the group of resources consisting of:
an edge resource of the edge resources,
a private cloud resource of the private cloud resources or a public cloud resource of the public cloud resources,
the edge resources of the edge resources after modification of the component for compatibility with the edge resource, and
as part of the deployment plan.

4. The method of claim 3, wherein the sub-scores comprise a resource intensity score that indicates a level of demand for computational resources required for desired operation of the component.

5. The method of claim 3, wherein the sub-scores comprise a dependency complexity score that indicates a level of dependency that the component has on other services.

6. The method of claim 3, wherein the sub-scores comprise a latency sensitivity score that indicates a level of immediacy with respect to response times required for desired operation of the component.

7. The method of claim 3, wherein the sub-scores comprise an architectural complexity score based on a set of factors related to an architectural structure of the component, the set of factors comprising:
modularity;
resiliency; and
edge compatibility.

8. The method of claim 1, wherein finalizing the deployment plan comprises:
iteratively performing simulations of operation of the using the deployment plan to obtain simulated outcomes;
while iteratively performing the simulations, iteratively making changes to the deployment plan until at least one of the simulated outcomes meets criteria; and
obtaining a finalized deployment plan based on the iteratively made changes to the deployment plan.

9. The method of claim 1, wherein updating the operation of the deployment comprises:
migrating at least a portion of the plurality of the components of the deployment that is hosted on a cloud resource of the cloud resources to an edge resource of the edge resources based on the finalized deployment plan.

10. A non-transitory machine-readable medium having instructions stored therein, which when executed by a processor, cause the processor to perform operations for managing operation of a deployment, the operations comprising:
obtaining data indicating operation of the deployment, the deployment comprising edge resources, private cloud resources, and public cloud resources, and the deployment hosting a plurality of components distributed across the edge resources, private cloud resources, and public cloud resources;
evaluating, using a scoring system, the data to obtain a deployment plan, the scoring system being adapted to, for at least one component of the plurality of components:
generate sub-scores for different characteristics of the at least one component indicated by the data,
combine the sub-scores to obtain an aggregate score for the at least one component, and
classify the at least one component with respect to edge compatibility based on the aggregate score;
finalizing the deployment plan to obtain a finalized deployment plan; and
updating operation of the deployment using the finalized deployment plan to facilitate provisioning of desired computer implemented services.

11. The non-transitory machine-readable medium of claim 10, wherein the data comprises at least one type of data from a list consisting of:
performance metrics for the deployment;
resource utilization data for the deployment;
information regarding dependencies for components of the deployment; and
configuration information for the deployment.

12. The non-transitory machine-readable medium of claim 11, wherein evaluating the data comprises:
generating, for a component of the plurality of components of the deployment, the sub-scores using the scoring system;
applying a weighting function to the sub-scores to obtain the aggregate score; and
classifying, based on the aggregate score, the component:
with respect to being hosted on at least one resource of a group of resources used by the deployment, the group of resources consisting of:
an edge resource of the edge resources,
a private cloud resource of the private cloud resources or a public cloud resource of the public cloud resources,
the edge resources of the edge resources after modification of the component for compatibility with the edge resource, and
as part of the deployment.

13. The non-transitory machine-readable medium of claim 12, wherein the sub-scores comprise a resource intensity score that indicates a level of demand for computational resources required for desired operation of the component.

14. The non-transitory machine-readable medium of claim 12, wherein the sub-scores comprise a dependency complexity score that indicates a level of dependency that the component has on other services.

15. The non-transitory machine-readable medium of claim 11, wherein the sub-scores comprise a latency sensitivity score that indicates a level of immediacy with respect to response times required for desired operation of the component.

16. A system, comprising:
a processor; and
a memory coupled to the processor to store instructions, which when executed by the processor, cause the processor to perform operations for managing operation of a deployment, the operations comprising:
obtaining data indicating operation of the deployment, the deployment comprising edge resources, private cloud resources, and public cloud resources, and the deployment hosting a plurality of components distributed across the edge resources, private cloud resources, and public cloud resources;
evaluating, using a scoring system, the data to obtain a deployment plan, the scoring system being adapted to, for at least one component of the plurality of components:
generate sub-scores for different characteristics of the at least one component indicated by the data,
combine the sub-scores to obtain an aggregate score for the at least one component, and
classify the at least one component with respect to edge compatibility based on the aggregate score;
finalizing the deployment plan to obtain a finalized deployment plan; and
updating operation of the deployment using the finalized deployment plan to facilitate provisioning of desired computer implemented services.

17. The system of claim 16, wherein the data comprises at least one type of data from a list consisting of:
performance metrics for the deployment;
resource utilization data for the deployment;
information regarding dependencies for components of the deployment; and
configuration information for the deployment.

18. The system of claim 17, wherein evaluating the data comprises:
generating, for a component of the plurality of components of the deployment, the sub-scores using the scoring system;
applying a weighting function to the sub-scores to obtain the aggregate score; and
classifying, based on the aggregate score, the component:
with respect to being hosted on at least one resource of a group of resources used by the deployment, the group of resources consisting of:
an edge resource of the edge resources,
a private cloud resource of the private cloud resources or a public cloud resource of the public cloud resources,
the edge resources of the edge resources after modification of the component for compatibility with the edge resource, and
as part of the deployment plan.

19. The system of claim 18, wherein the sub-scores comprise a resource intensity score that indicates a level of demand for computational resources required for desired operation of the component.

20. The system of claim 18, wherein the sub-scores comprise a dependency complexity score that indicates a level of dependency that the component has on other services.
